(19) United States
(12) Patent Application Publication
(10) Pub. No.: US 2009/0233158 A1
(43) Pub. Date: Sep. 17, 2009

(54) ELECTRIC POWER SUPPLY SYSTEM

(76) Inventor: Kenji Kimura, Aichi-ken (JP)

Correspondence Address: KENYON & KENYON LLP, 1500 K STREET N.W., SUITE 700, WASHINGTON, DC, 20005, US

(21) Appl. No.: 12/514,036

(22) PCT Filed: Nov. 24, 2007
(86) PCT No.: PCT/IB2007/003599

§ 371 Date: May 7, 2009

(30) Foreign Application Priority Data
Nov. 24, 2006 (JP) 2006-316972

(51) Int. Cl. H01M 10/50

(52) U.S. Cl. 429/62; 429/120

(57) ABSTRACT

A battery system having a cooling liquid that undergoes heat exchange with a battery assembly is reduced in size. The battery system in which a battery assembly is contained in a battery box is characterized by including the cooling liquid that is contained in the battery box and that undergoes heat exchange with the battery assembly, and a circulation passageway and a circulation pump that introduce a cooling gas lighter in specific gravity than the cooling liquid into the cooling liquid. The cooling gas floating up in the cooling liquid stirs the cooling liquid. This stirring action increases the flow rate of the cooling liquid, and therefore makes it possible to obtain high cooling capability even in a construction that employs a small-size circulation pump.

### BACKGROUND OF THE INVENTION

1. Field of the Invention

The invention relates to an electric power supply system in which an electric power supply device is contained in a container box, and more particularly to adjustment of the temperature of the electric power supply device.

2. Description of the Related Art

Vehicle-driving electric power supplies (e.g., secondary batteries, or fuel cells) mounted in hybrid electric motor vehicles, electric motor vehicles, fuel cell motor vehicles, etc. need to be cooled since a battery element thereof produces a gas if a proper temperature is exceeded.

As a cooling technology of this kind, a construction shown in FIG. 5 is disclosed in Japanese Patent Application Publication No. 2003-346924 (JP-A-2003-346924). In this drawing, a battery assembly 101 is contained in a box 102. This box 102 is filled with a cooling liquid. The box 102 is provided with a circulation passageway 103 that causes a cooling liquid to flow into the box 102 and that causes the cooling liquid to flow out from the box 102.

The circulation passageway 103 is provided with a circulation pump 104 for forcing the cooling liquid to circulate, and with a radiator 105 for cooling the cooling liquid that flows out from the box 102.

According to the foregoing construction, the cooling water whose temperature has risen due to the cooling of the battery assembly 101 can be cooled by the radiator 105, and can be sent into the box 102 again. Therefore, the battery assembly 101 can be efficiently cooled.

By increasing the flow rate of the cooling liquid that flows through the box 102, the cooling rate of the battery assembly 101 can be raised. Related technologies are also disclosed in Japanese Patent Application Publication No. 11-238530 (JP-A-11-238530), Japanese Patent No. 2746751, and the Japanese Patent Application Publication No. 2006-127921 (JP-A-2006-127921).

However, in order to increase the flow rate of the cooling liquid, it is necessary to heighten the pressure of the circulation pump 104, which involves the possibility of a size increase of the pump 104.

In particular, in battery assemblies for vehicles, since it is necessary to juxtapose a plurality of batteries in a limited space, the intervals between adjacent batteries need to be set small. However, reduced intervals between adjacent batteries cause a decline in the flow rate of the cooling liquid that flows along battery surfaces due to pressure loss, thus giving rise to a possibility of the cooling of the battery assembly 101 becoming insufficient. Therefore, in order to heighten the cooling capability, the pressure of circulation pump 104 needs to be heightened by increasing the size thereof.

### SUMMARY OF THE INVENTION

Accordingly, it is an object of the invention to reduce the size of an electric power supply system that has a heat-exchange fluid that undergoes heat exchange with an electric power supply device.

A first aspect of the invention is an electric power supply system in which an electric power supply device is contained in a container box, the system being characterized by including: a first heat-exchange fluid that is contained in the container box and that undergoes heat exchange with the electric power supply device; and an introduction device that introduces a second heat-exchange fluid lighter in specific gravity than the first heat-exchange fluid into the first heat-exchange fluid.

In this aspect, the first heat-exchange fluid may be a liquid, and the second heat-exchange fluid may be a liquid or a gas.

Besides, the introduction device may include a circulation passageway that returns the second heat-exchange fluid separated from the first heat-exchange fluid by a specific gravity difference into the first heat-exchange fluid.

Besides, the circulation passageway may be provided with a circulation pump that forces the second heat-exchange fluid to circulate.

Besides, the electric power supply system may further include a cooling device that cools the second heat-exchange fluid that is introduced into the first heat-exchange fluid via the circulation passageway.

Besides, the electric power supply system may further include a heating device that heats the second heat-exchange fluid that is introduced into the first heat-exchange fluid via the circulation passageway.

As a material of the second heat-exchange fluid, air, nitrogen an AT fluid or a silicon oil may be used.

According to the first aspect of the invention, the first heat-exchange fluid can be caused to flow by causing the second heat-exchange fluid to move in the first heat-exchange fluid due to a specific gravity difference. Therefore, even in the case where the flow rate of the second heat-exchange fluid when it is introduced into the first heat-exchange fluid is set relatively low, decline in the cooling capability can be curved.

### BRIEF DESCRIPTION OF THE DRAWINGS

FIG. 1 is a perspective view of a battery assembly;

FIG. 2 is a sectional view of a battery system;

FIG. 3 is a plan view of the battery system;

FIG. 4 is a sectional view of a battery system in accordance with a second embodiment; and

FIG. 5 is a schematic diagram of a related-art battery system.

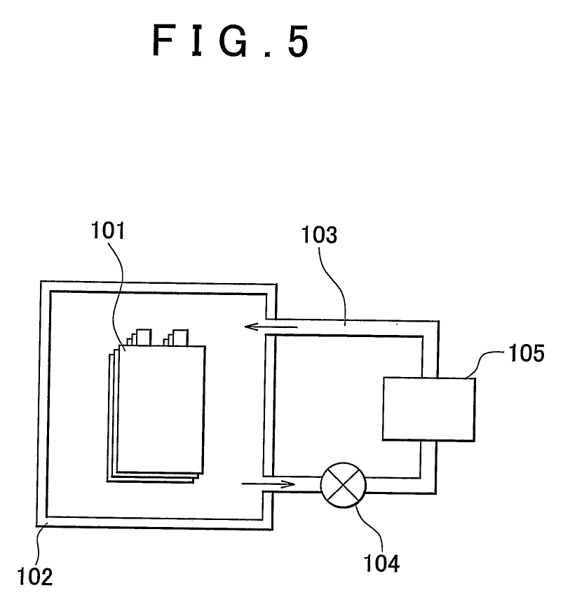

### DETAILED DESCRIPTION OF THE EMBODIMENTS

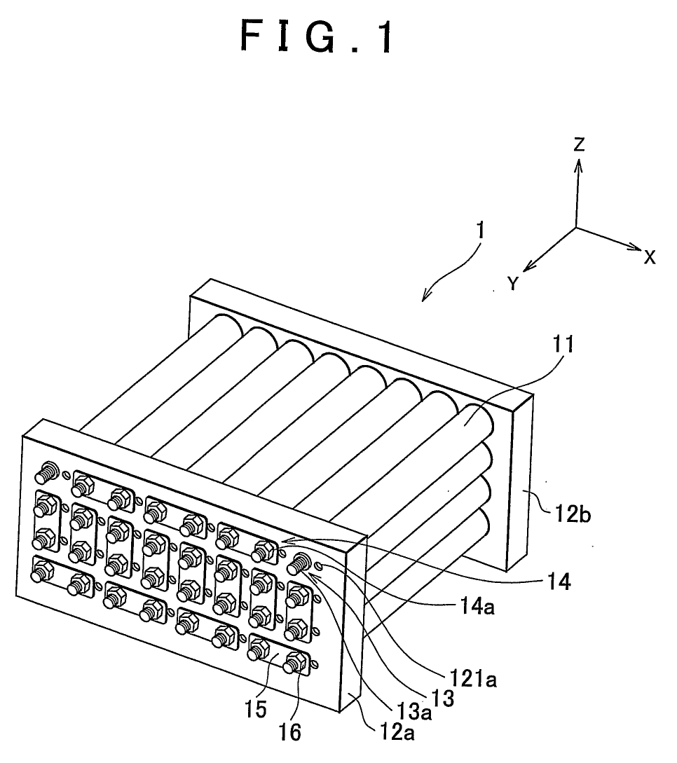

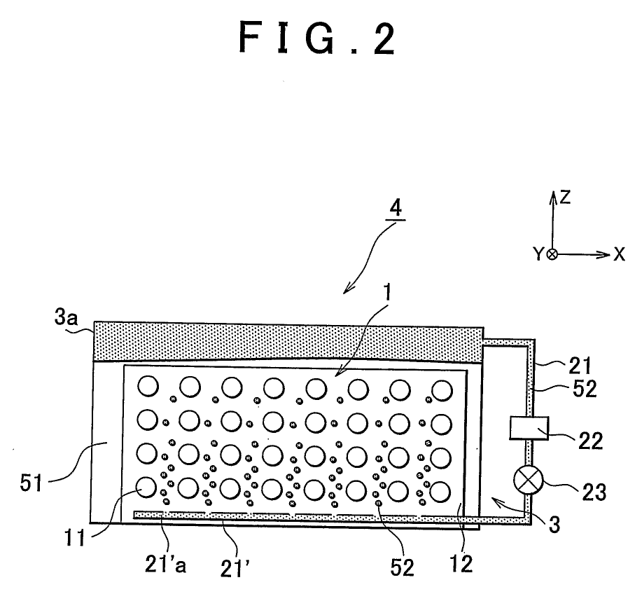

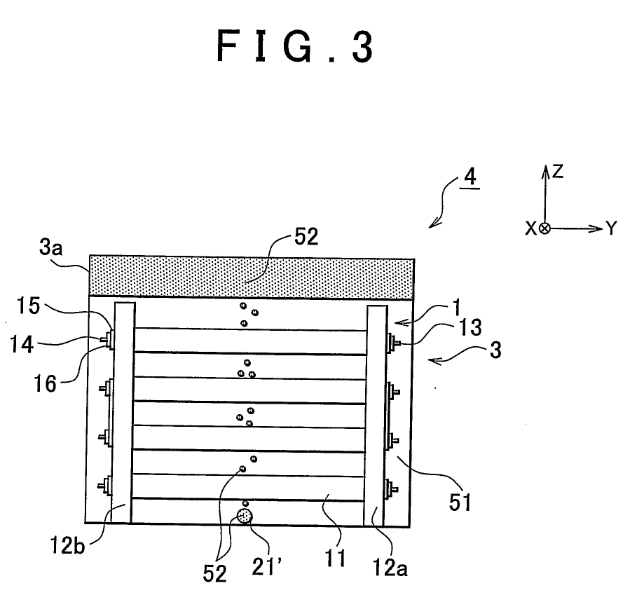

Embodiments of the invention will be described hereinafter with reference to the drawings. A first embodiment of the invention will be described below. FIG. 1 is a perspective view of a battery assembly 1 as an electric power supply device. FIG. 2 is a sectional view of a cylindrical battery of a battery system taken along a direction orthogonal to a lengthwise direction thereof. FIG. 3 is a sectional view of the cylindrical battery of the battery system taken along the lengthwise direction thereof.

Firstly, an overall construction of the battery system of the first embodiment will be described. In the battery system 4 of the first embodiment, a cooling liquid (first heat-exchange fluid) 51 is contained within a battery box 3 that contains the battery assembly 1. The battery system 4 also has a circulation passageway 21 for introducing a cooling gas (second heat-exchange fluid) 52 that is lighter in specific gravity than the cooling liquid 51 into the cooling liquid 51, and for returning the cooling gas 52 separated from the cooling liquid 51 due to the difference in specific gravity into the cooling liquid 51 after cooling the cooling gas 52 via a cooler 22.

By causing the cooling gas 52 to float up within the cooling liquid 51, the cooling liquid 51 can be stirred. This stirring action increases the flow rate of the cooling liquid 51 flowing along the surfaces of the cylindrical batteries 11, and therefore can raise the cooling rate of the battery assembly 1.

Besides, since the cooling gas 52 naturally floats up in the cooling liquid 51 due to the specific gravity difference therebetween, the pressure of a circulation pump (circulation device) 23 for sending the cooling gas 52 into the cooling liquid 51 can be set low. Therefore, the circulation pump 23 can be reduced in size.

Next, with reference to FIG. 1, the construction of the battery assembly 1 will be described in detail. The battery assembly 1 is constructed of a plurality of cylindrical batteries 11 extending between a pair of battery folders 12a, 12b that are disposed facing each other. Each cylindrical battery 11 is constructed of a lithium-ion battery. Two opposite ends of each cylindrical battery 11 are provided with positive and negative threaded shaft portions 13, 14, respectively, each of which has on its outer peripheral surface a thread-grooved portion 13a, 14a.

In each of the battery folders 12a, 12b, a plurality of insertion hole portions 121a, 121b (the insertion hole portions 121b are not shown) for inserting the positive and negative threaded shaft portions 13, 14 of the cylindrical batteries 11 are formed. In a mounted state, the positive and negative threaded shaft portions 13, 14 are protruded outward from the battery folder 12 through insertion hole portions 11a, 11b.

Adjacent cylindrical batteries 11 are disposed in opposite directions along the direction of an arrow Y (i.e., the orientations of the positive electrode and the negative electrode are set so as to oppose each other in the direction Y). Adjacent cylindrical batteries 11 are serially connected by bus bars 15.

The bus bars 15 are inserted on to the positive and negative threaded shaft portions 13, 14 of the cylindrical batteries 11. Fastening nuts 16 are placed over the bus bars 15 and are fastened to the positive and negative threaded shaft portions 13, 14, so that the cylindrical batteries 11 are fixed to the battery folders 12.

Next, with reference to FIGS. 2 and 3, the construction of the battery system 4 (the electric power supply system) will be described in detail.

The battery folders 12a, 12b of the battery assembly 1 are fixed to a bottom surface of the battery box 3, and the cylindrical batteries 11 are disposed in a direction parallel to the bottom surface of the battery box 3 (i.e., in a direction in an XY plane).

The battery box 3 contains the cooling liquid 51, in which the battery assembly 1 is submerged. Examples of the material of the cooling liquid 51 include a fluorine-based inert liquid that is high in heat conductivity and excellent in insulation characteristic.

Within the battery box 3, a space portion 3a is formed between a ceiling portion of the battery box 3 and the cooling liquid 51. The circulation passageway 21, linked to the space portion 3a in communication, has an extension pipe portion 21′ that extends between the battery assembly 1 and the bottom surface of the battery box 3.

The extension pipe portion 21′ is provided in a region immediately under central portions of the cylindrical batteries 11 in the lengthwise direction, and extends in the direction of the X-axis (the direction orthogonal to the lengthwise direction of the cylindrical battery 11 and parallel to the bottom surface of the battery box 3).

Besides, the extension pipe portion 21′ has a plurality of coolant discharge opening portions 21′a that are aligned in the direction of the passageway. The pitch of the coolant discharge opening portions 21′a is set substantially equal to the pitch of the cylindrical batteries 11 in the direction of an arrow X (the direction of the passageway).

The circulation passageway 21 is provided with the circulation pump 23 for forcing the cooling gas 52 into the extension pipe portion 21′, and the cooler (cooling device) 22 for cooling the cooling gas 52 that flows thereinto from the space portion 3a.

Examples of the material of the cooling gas 52 include air and nitrogen. Incidentally, the circulation passageway 21 and the circulation pump 23 constitute an introduction device described in the appended claims.

Next, the cooling operation of the battery system 4 performed to cool the battery assembly 1 will be described.

When the temperature of the battery assembly 1 heated due to the charging or discharging of electricity exceeds a threshold value (e.g., 60° C.), the circulation pump 23 and the cooler 22 are driven. The battery assembly 1 is provided with a temperature detection sensor. The circulation pump 23 and the cooler 22 are driven on the basis of the temperature information from the temperature detection sensor.

Due to the cooling of the heated battery assembly 1, the temperature of the cooling liquid 51 (in particular, of regions around cylindrical batteries 11, and an upper-side region of the cooling liquid 51) is higher than before the circulation pump 23 is started to drive. In other words, after the circulation pump 23 is started to drive, heat transfers efficiently from the heated battery assembly 1 to the cooling liquid 51.

The cooling gas 52 sent out into the extension pipe portion 21′ due to the pressure action of the circulation pump 23 is discharged from the coolant discharge opening portions 21′a into the cooling liquid 51, in the form of bubbles.

Bubbles of the cooling gas 52 float up in the cooling liquid 51 due to the specific gravity difference, and reach the space portion 3a.

As the cooling gas 52 floats up in the cooling liquid 51, heat transfers from the cooling liquid 51 to the cooling gas 52, so that the cooling liquid 51 is cooled. Therefore, the cooling rate of the battery assembly 1 can be raised.

Besides, the cooling gas 52 floating up in the cooling liquid 51 stirs the cooling liquid 51. Therefore, the flow rate of the cooling liquid 51 flowing along the surfaces of the cylindrical batteries 11 increases, so that the cooling rate of the battery assembly 1 will be raised.

Besides, since the cooling gas 52 floats up in the cooling liquid 51 due to the specific gravity difference, there is no need to heighten the pressure of the circulation pump 23 in order to cause the cooling gas 52 to float up. Therefore, the circulation pump 23 can be reduced in size.

The cooling gas 52 released into the space portion 3a flows into the circulation passageway 21, and is cooled by the cooling action of the cooler 22, and then is introduced into the cooling liquid 51 again by the circulation pump 23.

Thus, in the first embodiment, an end of the circulation passageway 21 is linked to the space portion 3a of the battery box 3 in communication, and the other end of the circulation passageway 21 extends in a region below the battery assembly 1 within the battery box 3, and the circulation passageway 21 can be made as a closed system. Therefore, it becomes possible to stop the entrance of an undesired substance from outside the circulation passageway 21, and to prevent the impairment of the insulation property of the cooling liquid 51 and the cooling gas 52.

Modifications of the first embodiment will be described below. Instead of the cooling gas 52, a cooling liquid lighter in specific gravity than the cooling liquid 51 (e.g., AT fluid or silicon oil) can be used.

Furthermore, it is also permissible to employ a construction in which cool air is led into the cooling liquid 51 from a radiator that cools the battery box 3 from outside. This allows the cooler 22 to be omitted, and therefore allows a cost reduction.

Furthermore, although the extension pipe portion 21′ is formed by one pipe, a plurality of pipes may be employed. Due to the provision of a plurality of extension pipe portions 21′, the cooling gas 52 can be uniformly discharged into the cooling liquid 51. Therefore, the cooling rate of the battery assembly 1 can be further improved.

Furthermore, although in the foregoing embodiment, the coolant discharge opening portions 21′a formed in the extension pipe portion 21′ are equally pitched, the pitch of the coolant discharge opening portions 21′a may be set in accordance with the temperature distribution in the battery assembly 1. For example, in the case where there is a high-temperature region in the battery assembly 1 in which the temperature is higher than in other regions, the coolant discharge opening portions 21′a may be formed so that the cooling gas 52 is discharged concentratedly to the high-temperature region.

Furthermore, since the cooling liquid 51 having higher temperature moves to an upper side, it is also permissible to employ a construction in which the extension pipe portion 21′ is disposed at a position higher than in the first embodiment, so that an upper-side portion of the cooling liquid 51 is concentratedly cooled.

A second embodiment of the invention will be described.

An overall construction of a battery system of the second embodiment will be described. In the battery system 5 of the second embodiment, a heat-exchange liquid (first heat-exchange fluid) 53 is contained within a battery box 3 that contains a battery assembly 1. The battery system 5 also has a circulation passageway 21 for introducing a heat-exchange gas (second heat-exchange fluid) 54 that is lighter in specific gravity than the heat-exchange liquid 53 into the heat-exchange liquid 53, and for returning the heat-exchange gas 54 separated from the heat-exchange liquid 53 due to the difference in specific gravity into the heat-exchange liquid 53 after cooling or heating the heat-exchange gas 54 via a cooler 22.

By causing the heated heat-exchange gas 54 to float up in the heat-exchange liquid 53, the heat-exchange liquid 53 can be stirred. This stirring action increases the flow rate of the heat-exchange liquid 53 flowing along the surfaces of the cylindrical batteries 11, therefore can quickly raise the temperature of the battery assembly 1 to a proper temperature if the battery assembly 1 has low temperature (e.g., −10° C.).

Besides, since the heat-exchange gas 54 naturally rises in the heat-exchange liquid 53 due to the specific gravity difference therebetween, the pressure of the circulation pump 23 for sending the heat-exchange gas 54 into the heat-exchange liquid 53 can be set low. Therefore, the circulation pump 23 can be reduced in size.

In the case where the cooled heat-exchange gas 54 is introduced into the heat-exchange liquid 53, substantially the same effect as in the first embodiment can be achieved. In addition, as the heat-exchange liquid 53, the same material as used for the cooling liquid 51 in the first embodiment can be used.

Besides, as the heat-exchange gas 54, the same material as used for the cooling gas 52 in the first embodiment may be used, and may be a liquid, for example, an AT fluid, a silicon oil, etc., that is lighter in specific gravity than a fluorine-based inert liquid.

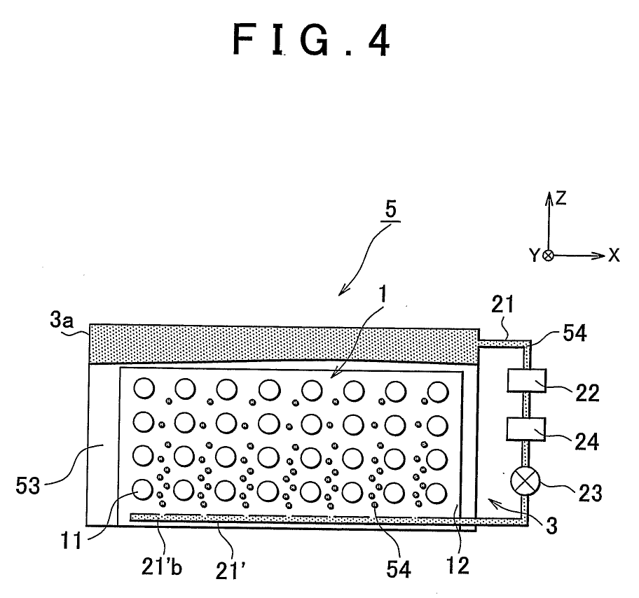

Next, with reference to FIG. 4, the construction of the battery system 5 of the second embodiment will be described in detail. FIG. 4 is a sectional view of the battery system 5 of the second embodiment. The same component elements as those in the first embodiment will be suffixed with the same reference characters, and the detailed description thereof will be omitted.

The circulation passageway 21 linked to a space portion 3a in communication is provided with the cooler (cooling device) 22, a heater (heating device) 24 and the circulation pump 23. The cooler 22 cools the heat-exchange gas 54 that flows in from the space portion 3a. The heater 24 heats the heat-exchange gas 54 that flows in from the space portion 3a.

The battery assembly 1 is provided with a temperature detection sensor (not shown). The cooler 22, the heater 24 and the circulation pump 23 are driven on the basis of the temperature information from the temperature detection sensor. Incidentally, the cooler 22, the heater 24 and the circulation pump 23 are driven by a control circuit (not shown).

Next, the cooling operation of the battery system 5 performed to cool the battery assembly 1 will be described. If the control circuit determines that the temperature of the battery assembly 1 is lower than the proper temperature (e.g., −10° C. to 60° C.) on the basis of the temperature information from the temperature detection sensor, the control circuit drives the heater 24 and the circulation pump 23.

The heat-exchange gas 54 sent out into the extension pipe portion 21′ due to the pressure action of the circulation pump 23 is discharged from the heat-exchange discharge opening portions 21′b into the heat-exchange liquid 53 in the form of bubbles.

Bubbles of the heat-exchange gas 54 float up in the heat-exchange liquid 53 due to the specific gravity difference, and reach the space portion 3a.

As the heat-exchange gas 54 floats up in the heat-exchange liquid 53, heat transfers from the heat-exchange gas 54 to the heat-exchange liquid 53, so that the heat-exchange liquid 53 is heated. Therefore, the temperature of the battery assembly 1 can be quickly raised to a proper temperature.

Besides, the heat-exchange gas 54 floating up in the heat-exchange liquid 53 stirs the heat-exchange liquid 53. Therefore, the flow rate of the heat-exchange liquid 53 flowing along the surfaces of the cylindrical batteries 11 increases, so that the cooling rate of the battery assembly 1 will be raised.

Besides, since the heat-exchange gas 54 floats up in the heat-exchange liquid 53 due to the specific gravity difference, there is no need to heighten the pressure of the circulation pump 23 in order to cause the heat-exchange gas 54 to float up. Therefore, the circulation pump 23 can be reduced in size.

The heat-exchange gas 54 released into the space portion 3a flows into the circulation passageway 21, and is heated by the heating action of the heater 24, and then is introduced into the heat-exchange liquid 53 by the circulation pump 23 again.

Thus, in the second embodiment, an end of the circulation passageway 21 is linked to the space portion 3a of the battery box 3 in communication, and the other end of the circulation passageway 21 extends in a region below the battery assembly 1 within the battery box 3, and the circulation passageway 21 can be made as a closed system. Therefore, it becomes possible to stop the entrance of an undesired substance from outside the circulation passageway 21 into the heat-exchange liquid 53 and the heat-exchange gas 54, and to prevent the impairment of the insulation property of the heat-exchange liquid 53 and the heat-exchange gas 54.

If the temperature of the battery assembly 1 is beyond the proper temperature, the cooler 22 and the circulation pump 23 are driven to quickly cool the battery assembly 1 as in the first embodiment.

Although in the second embodiment, the heat-exchange gas 54 cooled by the heat-exchange liquid 53 is heated by the heater 24, it is also permissible to employ a construction in which, for example, a portion of the exhaust gas from the vehicle or a portion of hot air jetted from the airconditioner provided in the cabin is introduced into the heat-exchange liquid 53. This allows the heater 24 to be omitted, and therefore allows a cost reduction of the battery system 5.

Although in the foregoing first and second embodiments, the cylindrical batteries 11 are lithium-ion batteries, it is also permissible to use other types of secondary batteries (electric power supply device), capacitors (electric power supply device), and a fuel cell (electric power supply device).

These electric power supply devices can be used as an electric power supply for driving a motor in, for example, in the electric motor vehicles (EV), hybrid electric motor vehicles (HEV), and fuel cell vehicles (FCV).

While the invention has been described with reference to the example embodiment thereof, it is to be understood that the invention is not limited to the example embodiment and construction. To the contrary, the invention is intended to cover various modifications and equivalent arrangements. In addition, while the various elements of the example embodiment are shown in various combinations and configurations, which are exemplary, other combinations and configurations, including more, less or only a single element, are also within the sprit and scope of the invention.

1. An electric power supply system comprising:
a container box;
an electric power supply device contained in the container box;
a first heat-exchange fluid that is contained in the container box and that undergoes heat exchange with the electric power supply device; and
an introduction device that introduces a second heat-exchange fluid lighter in specific gravity than the first heat-exchange fluid into the first heat-exchange fluid.

2. The electric power supply system according to claim 1, wherein the first heat-exchange fluid is a liquid, and the second heat-exchange fluid is a liquid or a gas.

3. The electric power supply system according to claim 1, wherein the introduction device has a circulation passageway that returns the second heat-exchange fluid separated from the first heat-exchange fluid by a specific gravity difference into the first heat-exchange fluid.

4. The electric power supply system according to claim 1, wherein the circulation passageway is provided with a circulation pump that forces the second heat-exchange fluid to circulate.

5. The electric power supply system according to claim 3, further comprising a cooling device that cools the second heat-exchange fluid that is introduced into the first heat-exchange fluid via the circulation passageway.

6. The electric power supply system according to claim 3, further comprising a heating device that heats the second heat-exchange fluid that is introduced into the first heat-exchange fluid via the circulation passageway.

7. The electric power supply system according to claim 5, further comprising a temperature detection sensor that detects temperature of an electric power supply device, wherein the circulation pump is operated when the temperature of the electric power supply device is higher than a pre-set temperature.

8. The electric power supply system according to claim 6, further comprising a temperature detection sensor that detects temperature of an electric power supply device, wherein the circulation pump is operated when the temperature of the electric power supply device is lower than a pre-set temperature.

9. The electric power supply system according to claim 1, wherein the second heat-exchange fluid is an AT fluid or a silicon oil.

10. The electric power supply system according to claim 1, wherein the second heat-exchange fluid is air or nitrogen.

11. The electric power supply system according to claim 4, further comprising a cooling device that cools the second heat-exchange fluid that is introduced into the first heat-exchange fluid via the circulation passageway.

12. The electric power supply system according to claim 4, further comprising a heating device that heats the second heat-exchange fluid that is introduced into the first heat-exchange fluid via the circulation passageway.

13. The electric power supply system according to claim 11, further comprising a temperature detection sensor that detects temperature of an electric power supply device, wherein the circulation pump is operated when the temperature of the electric power supply device is higher than a pre-set temperature.

14. The electric power supply system according to claim 12, further comprising a temperature detection sensor that detects temperature of an electric power supply device, wherein the circulation pump is operated when the temperature of the electric power supply device is lower than a pre-set temperature.
